(19) United States
(12) Patent Application Publication
(10) Pub. No.: US 2020/0113218 A1
(43) Pub. Date: Apr. 16, 2020

(54) A SAVOURY CONCENTRATE

(71) Applicant: Conopco Inc., d/b/a UNILEVER, Englewood Cliffs, NJ (US)

(72) Inventors: Leonardus Marcus Flendrig, Vlaardingen (NL); Hendrikus Theodorus Wilhelmus Maria van der Hijden, Vlaardingen (NL); Marc Lemmers, Vlaardingen (NL); Winfried Sailer, Heilbronn (DE)

(73) Assignee: Conopco Inc., d/b/a UNILEVER, Englewood Cliffs, NJ (US)

(21) Appl. No.: 16/499,901

(22) PCT Filed: Mar. 27, 2018
(86) PCT No.: PCT/EP2018/057739

§ 371 Date: Oct. 1, 2019

(30) Foreign Application Priority Data
Apr. 18, 2017 (EP) 17166733.0

(51) Int. Cl. A23L 29/212; A23L 29/00

(52) U.S. Cl. CPC A23L 29/212; A23L 29/05; A23L 23/10; A23L 29/035; A23L 29/015; A23L 29/045

(57) ABSTRACT

The present invention relates to a savoury concentrate comprising:
a. at least 30 wt. %, by weight of the concentrate, of an oil phase comprising liquid oil;
b. 3-30 wt. %, by weight of the concentrate, of an edible salt;
c. 1-50 wt. %, by weight of the concentrate, of savoury taste giving ingredients;
d. up to 10 wt. %, by weight of the concentrate, of water; and
e. expanded gelatinized starch particles;
   wherein the expanded gelatinized starch particles are dispersed in the oil phase in a concentration of 0.5 to 35 wt. %, by weight of the combined weight of the liquid oil and the gelatinized starch particles.

The invention further relates to a method for the preparation of the savoury concentrate and to a process for preparing a ready-to-eat savoury product using the savoury concentrate.

### FIELD OF THE INVENTION

The present invention relates to savoury concentrates comprising oil, edible salt, savoury taste giving ingredients; starch and optionally further ingredients. The invention further relates to a method for the preparation of said savoury concentrate and to a process for preparing a ready-to-eat savoury product using said savoury concentrate.

### BACKGROUND OF THE INVENTION

Savoury concentrates are well-known in the art. These concentrates provide a convenient way of preparing, for instance, a soup, a sauce or can be used as a seasoning for a dish. Examples of savoury concentrates include dry concentrates, such as dry soup and bouillon cubes, liquid concentrates such as condensed soups, concentrated sauces and gelled concentrates. Savoury concentrates in the form of pastes are also known. Savoury concentrates are usually combined with hot water and optionally further food ingredients, such as vegetables or a protein source, to prepare a ready-to-eat savoury product (e.g. a bouillon, a soup, a sauce or a gravy).

Savoury concentrates typically have a shelf-life of several months at ambient temperature. Savoury concentrates that comprise high levels of liquid oil, such as vegetable oil, tend to show oil exudation during storage over time. Oil exudation results in the formation of an oily layer within the product package. This renders the product unattractive and may even cause consumers to reject the product.

Oil exudation in savoury concentrates can be minimized by mixing liquid oil with a high melting fat component. Examples of such high melting fat components are hydrogenated vegetable oils (e.g. fully hydrogenated rapeseed oil) or high melting palm oil fractions (palm stearins). However, these high melting fat components, unlike the liquid oil, contain high levels of saturated fatty acids. Fats that contain high levels of saturated fatty acids are generally regarded as less healthy than liquid oils that contain high levels of unsaturated fatty acids.

In addition, if these savoury concentrates with high melting fats are transported in tropical countries in trucks without temperature control, the temperature within the truck may easily rise far above the melting temperature of the high melting fats, which affects the stability of the savoury concentrates, e.g. undesired layers are formed in the savoury concentrate.

Therefore there is a clear consumer need to obtain a stable savoury concentrate for the preparation of e.g. sauces, which contains a high level of liquid oil, but does not suffer from oil exudation or undesired layer formation.

### SUMMARY OF THE INVENTION

The inventors of the present invention have developed a savoury concentrate that meets these consumer needs.

The inventors have unexpectedly found that oil exudation in savoury concentrates can be minimized effectively by introducing expanded gelatinized starch particles into the liquid oil component of the savoury concentrate. It was discovered that these expanded gelatinized starch particles are capable of forming an oil-retaining matrix within the liquid oil component. Unlike high melting fat, the oil-structuring properties of the expanded gelatinized starch particles are not affected by a temperature increase.

The presence of the expanded gelatinized starch particles in the savoury concentrate has no adverse impact on the taste and mouthfeel of the ready-to-eat savoury products that are prepared from these concentrates.

The expanded gelatinized starch particles of the present invention can be prepared by heating a starch-rich material in the presence of water to gelatinize the starch and to turn the water to steam. Due to the pressure increase that accompanies heat-induced steam formation and due to the soft ‘rubbery’ state of the gelatinized starch, a foam structure is formed within the starch-rich material, when the pressure subsequently drops. Subsequent cooling causes the gelatinized starch in the foam structure to move from rubbery to a glassy state, thereby imparting rigidity to the foam structure. The rigid foam structure can be milled or otherwise comminuted to produce expanded gelatinized starch particles that can be applied in the savoury concentrate of the present invention.

EP-A 0 097 847 describes a process for preparing foamed gelatinized starch products wherein granular or pulverized starch or starch-containing materials are heated in an extruder press at temperatures of 60-220° C. in the presence of 10-30 wt. % of water and a gas-forming or gas-generating expanding agent and then extruded. In finely pulverized form the foamed starch is a suitable means for retaining the fluidity of powders that tend to cake together. The comminuted foam material is also suitable for use as a disintegrating agent in tablets. In the form of lumps or granules the foamed starch products may also be fried in oil to produce crisp products

Accordingly, the savoury concentrate according to the invention comprises:

a) at least 30 wt. %, by weight of the concentrate, of an oil phase comprising liquid oil;
b) 3-30 wt. %, by weight of the concentrate, of an edible salt selected from sodium chloride, potassium chloride and combinations thereof;
c) 1-50 wt. %, by weight of the concentrate, of savoury taste giving ingredients selected from glutamate, 5′-ribonucleotides, sucrose, glucose, fructose, lactic acid, citric acid and combinations thereof;
d) up to 10 wt. %, by weight of the concentrate, of water; and
e) expanded gelatinized starch particles, said particles comprising, by weight of the particles, at least 50 wt. % of starch, and wherein at least 80 wt. % of said particles passes a sieve with a mesh size of 2000 μm;
wherein the expanded gelatinized starch particles are dispersed in the oil phase in a concentration of 0.5 to 35 wt. %, by weight of the combined weight of the liquid oil and the gelatinized starch particles;
whereby
said water content of the savoury concentrate refers to the total water content, thus including the water that is present within the ingredients of the savoury concentrate.

The present invention further pertains to a method for the preparation of a savoury concentrate according to the invention, said method comprises the combining of the following components:
a. 100 parts by weight of an oil phase comprising liquid oil;
b. 0.5-35 parts by weight of expanded gelatinized starch particles, said particles comprising, by weight of the particles, at least 50 wt. % of starch, and wherein at least 80 wt. % of said particles passes a sieve with a mesh size of 2000 μm;
c. 4-100 parts by weight of an edible salt selected from sodium chloride, potassium chloride and combinations thereof;
d. 1-170 parts by weight of savoury taste giving ingredients selected from glutamate, 5′-ribonucleotides, sucrose, glucose, fructose, lactic acid, citric acid and combinations thereof;
   wherein the prepared savoury concentrate comprises not more than 10 wt. % water.

The present invention further relates to a process of preparing a ready-to-eat savoury product, using the savoury concentrate according to the invention.

### BRIEF DESCRIPTION OF THE FIGURES

FIG. 1 is a micrograph of a popcorn particle, obtained by SEM.

FIG. 2 is another micrograph of the popcorn particle.

In example 7 is described how these micrographs were obtained.

### DETAILED DESCRIPTION OF THE INVENTION

A first aspect of the invention relates to a savoury concentrate comprising:
a) at least 30 wt. %, by weight of the concentrate, of an oil phase comprising liquid oil;
b) 3-30 wt. %, by weight of the concentrate, of an edible salt selected from sodium chloride, potassium chloride and combinations thereof;
c) 1-50 wt. %, by weight of the concentrate, of savoury taste giving ingredients selected from glutamate, 5′-ribonucleotides, sucrose, glucose, fructose, lactic acid, citric acid and combinations thereof;
d) up to 10 wt. %, by weight of the concentrate, of water; and
e) expanded gelatinized starch particles, said particles comprising, by weight of the particles, at least 50 wt. % of starch, and wherein at least 80 wt. % of said particles passes a sieve with a mesh size of 2000 μm;
wherein the expanded gelatinized starch particles are dispersed in the oil phase in a concentration of 0.5 to 35 wt. %, by weight of the combined weight of the liquid oil and the gelatinized starch particles
whereby said water content of the savoury concentrate refers to the total water content, thus including the water that is present within the ingredients of the savoury concentrate.

The word ‘comprising’ as used herein is intended to mean ‘including’ but not necessarily ‘consisting of’ or ‘composed of’. In other words, the listed steps or options need not be exhaustive.

Unless specified otherwise, numerical ranges expressed in the format ‘from x to y’ or ‘x-y’ are understood to include x and y. When for a specific feature multiple preferred ranges are described in the format ‘from x to y’ or ‘x-y’, it is understood that all ranges combining the different endpoints are also contemplated. For the purpose of the invention ambient temperature is defined as a temperature of about 20° C.

Unless indicated otherwise, weight percentages (wt. %) are based on the total weight of the concentrate.

The terms ‘fat’ or ‘oil’ are used interchangeably, unless specified otherwise. The terms ‘fat’ and ‘oil’ as used herein refers to glycerides selected from triglycerides, diglycerides, monoglycerides, phosphoglycerides, free fatty acids and combinations thereof. Where applicable the prefix ‘liquid’ or ‘solid’ is added to indicate whether the fat or oil is liquid or solid at 20° C. “Hard stock” is an example of a solid fat. Hard stock typically has a solid fat content at 20° C. (N₂₀) of at least 30%.

The solid fat content of the oil phase can suitably be determined using the method described in Animal and vegetable fats and oils—Determination of solid fat content by pulsed NMR—Part 1: Direct method—ISO 8292-1:2008.

The term “gelatinized starch” as used herein refers to starch that has undergone gelatinization. Starch gelatinization is a process that breaks down the intermolecular bonds of starch molecules in the presence of water and heat, allowing the hydrogen bonding sites to engage more water. Penetration of water increases randomness in the general starch granule structure and decreases the number and size of crystalline regions. Under the microscope in polarized light starch loses its birefringence and its extinction cross during gelatinization. Some types of unmodified native starches start swelling at 55° C., other types at 85° C. The gelatinization temperature depends on the degree of cross-linking of the amylopectin. The extent to which the starch present in the expanded gelatinized starch particles is gelatinized can suitably be determined by cross polarised light microscopy.

The water content of the savoury concentrate refers to the total water content, thus including the water that is present within the ingredients of the savoury concentrate.

The particle size distribution of the expanded gelatinized starch particles can suitably be determined by means of sieving, i.e. by employing a set of sieves of different mesh sizes. The sieving may be carried out on the dry particles, but may also be carried out on a relatively dilute dispersion of the particles in a hydrophobic medium, such as for instance a liquid triglyceride oil.

The ‘oil exudation’ can suitably be quantified by means of the method as explained below in the examples. An amount of free oil of not more than 1 wt. %, preferably not more than 0.5 wt. %, by weight of the total savoury concentrate, is considered to be acceptable.

The term ‘bulk density’ as used herein, unless indicated otherwise, refers to freely settled bulk density.

### Savoury Concentrate

The savoury concentrate according to invention is preferably in solid form or in the form of a paste. More preferably the savoury concentrate is in the form of a paste, i.e. a very thick viscous fluid.

The savoury concentrate preferably comprises, by weight of the concentrate, 33-75 wt. % of the oil phase, more preferably 36-70 wt. % of the oil phase and most preferably 40-65 wt. %, of the oil phase.

Preferably, the oil phase has a solid fat content at 20° C. (N₂₀) of 0-15% and a liquid oil content at 20° C. that equals 100%-N₂₀.

The oil phase in the savoury concentrate more preferably has a solid fat content at 20° C. (N₂₀) of less than 10%, even more preferably a N₂₀ of less than 5% and most preferably a N₂₀ of 0%.

The oil phase in the savoury concentrate preferably has a solid fat content at 35° C. (N₃₅) of less than 5%, more preferably a N₃₅ of less than 3% and most preferably a N₃₅ of 0%.

Preferably, the oil phase contains at least 30 wt. % of vegetable oil, more preferably at least 50 wt. % of vegetable oil, even more preferably at least 70 wt. % and most preferably the oil phase contains at least 90 wt. % of vegetable oil. Examples of vegetable oils that may be employed include sunflower oil, soybean oil, rapeseed oil, cottonseed oil, maize oil, olive oil, palm oil, palm kernel oil, coconut oil, fractions of these oils and combinations thereof.

The oil phase of the present invention preferably does not comprise hydrogenated fat.

The savoury concentrate preferably comprises, by weight of the concentrate, 5-25 wt. %, more preferably 8-20 wt. %, of the edible salt, selected from sodium chloride, potassium chloride and combinations thereof. Preferably the edible salt is sodium chloride.

The savoury concentrate preferably comprises, by weight of the concentrate, 5-40 wt. %, preferably 10-30 wt. %, of the savoury taste giving ingredients, selected from glutamate, 5′-ribonucleotides, sucrose, glucose, fructose, lactic acid, citric acid and combinations thereof.

Preferably, these savoury taste giving ingredients may be added as such or as part of a more complex ingredient like a yeast extract, meat extract, plant extract or a fish extract.

The savoury concentrate preferably comprises, by weight of the concentrate, up to 9 wt. % of water, more preferably up to 8 wt. % of water.

Preferably, the expanded gelatinized starch particles are dispersed in the oil phase in a concentration of 1 to 33 wt. %, more preferably 2-30 wt. %, most preferably 4-27 wt. %, by weight of the combined weight of the liquid oil and the expanded gelatinized starch particles.

The “wt. % of the expanded gelatinized starch particles, by weight of the combined weight of the liquid oil and the expanded gelatinized starch particles”, as used herein, is calculated by dividing: [100×the weight of the expanded gelatinized starch particles] by: [weight of the liquid oil+weight of the expanded gelatinized starch particles].

Preferably, the oil phase is a structured oil phase due to the presence of the expanded gelatinized starch particles.

The inventors have found that the expanded gelatinized starch particles can take over the structuring function of the high melting fat component that is typically applied in such savoury concentrates to prevent oil exudation. The high melting fat component and the expanded gelatinized starch particles can be used in combination to structure the liquid oil component of the savoury concentrate.

Typically, the sum of (i) the wt. % of expanded gelatinized starch particles, by weight of the combined weight of the liquid oil and the gelatinized starch particles, and (ii) the percentage of solid fat content in the oil phase at 20° C. (N₂₀), lies within the range of 5-35, more preferably this sum lies within the range of 6-33, even more preferably within the range of 7-30, yet even more preferably within the range of 8-28 and most preferably this sum lies within the range of 10-25.

Preferably, the components a) to e) of the savoury concentrate together constitute at least 60 wt. % of the savoury concentrate. More preferably, the components a) to e) of the savoury concentrate together constitute at least 65 wt. % of the savoury concentrate. Most preferably, the components a) to e) of the savoury concentrate together constitute at least 70 wt. % of the savoury concentrate.

The ratio of dry matter by weight to the oil phase by weight, in the savoury concentrate, lies within the range of 2:1 to 0.2:1. More preferably, said weight ratio in the savoury concentrate lies within the range of 1.8:1 to 0.5:1.

The savoury concentrate preferably has a water activity (A_{w}) within the range of 0.15-0.6, more preferably within the range of 0.2-0.55 and most preferably within the range of 0.25-0.50.

The savoury concentrate preferably comprises, by weight of the concentrate, not more than 25 wt. % of sugars selected from sucrose, glucose, fructose and combinations thereof. More preferably, the savoury concentrate comprises, by weight of the concentrate, not more than 20 wt. % of said sugars.

The savoury concentrate preferably comprises, by weight of the concentrate, 0.1-50 wt. % of particulate plant material selected from herbs, spices, vegetables and combinations thereof. More preferably, the savoury concentrate comprises, by weight of the concentrate 1-40 wt. % of said particulate plant material and most preferably 5-35 wt. % of said particulate plant material.

Preferably, the particulate plant material has a mass weighted average diameter in the range of 50 to 3,000 μm, more preferably in the range of 80 to 1,000 μm and most preferably in the range of 100 to 500 μm.

In a particularly preferred embodiment, the savoury concentrate comprises:
a) 40-65 wt. %, by weight of the concentrate, of the oil phase having a solid fat content at 20° C. (N₂₀) of 0-5% and a liquid oil content at 20° C. that equals 100%-N₂₀;
b) 8-20 wt. %, by weight of the concentrate, of an edible salt selected from sodium chloride, potassium chloride and combinations thereof;
c) 10-30 wt. %, by weight of the concentrate, of savoury taste giving ingredients selected from glutamate, 5′-ribonucleotides, sucrose, glucose, fructose, lactic acid, citric acid and combinations thereof;
d) up to 8 wt. %, by weight of the concentrate, of water;
e) expanded gelatinized starch particles, said particles comprising, by weight of the particles, at least 50 wt. % of starch, and wherein at least 80 wt. % of said particles passes a sieve with a mesh size of 2000 μm
f) 5-35 wt. % of particulate plant material selected from herbs, spices, vegetables and combinations thereof; and
g);
wherein the expanded gelatinized starch particles are dispersed in the oil phase in a concentration of 4 to 27 wt. %, by weight of the combined weight of the liquid oil and the gelatinized starch particles; and
wherein the sum of (i) the wt. % of expanded gelatinized starch particles, by weight of the combined weight of the liquid oil and the gelatinized starch particles, and (ii) the percentage of solid fat content in the oil phase at 20° C. (N₂₀), lies within the range of 10-25; whereby
said water content of the savoury concentrate refers to the total water content, thus including the water that is present within the ingredients of the savoury concentrate.

### Expanded Gelatinized Starch Particles

The expanded gelatinized starch particles according to the invention preferably comprise, by weight of the particles, at least 60 wt. % of starch. More preferably, the expanded gelatinized starch particles comprise, by weight of the particles, at least 70 wt. % of starch and most preferably at least 80 wt. % of starch.

According to a preferred embodiment, at least 80 wt. %, more preferably at least 90 wt. % of the starch within the gelatinized starch particles is gelatinized.

The inventors have found that the lower the bulk density of the expanded gelatinized starch particles, the better these expanded gelatinized starch particles are capable of preventing oil exudation in the savoury concentrate.

The expanded gelatinized starch particles preferably have a bulk density that falls within the range of 5-220 g/I. More preferably, the expanded gelatinized starch particles have a bulk density that falls within the range of 15-190 g/I, most preferably abulk density that falls within the range of 30-170 g/I.

The expanded gelatinized starch particles are preferably selected from:
i. particles of puffed seed endosperm;
ii. extrusion expanded starch particles;
   and combinations thereof.

The particles of puffed seed endosperm can be suitably obtained by puffing of seed endosperm, followed by milling or other methods of size reduction. The term “puffing” as used herein also encompasses popping of seed endosperm.

Puffing of seed endosperm requires a high starch content. Preferably, the seed endosperm has a starch content of at least 50 wt. %, more preferably of at least 60. wt. % and most preferably of at least 70 wt. %, by weight of dry matter.

Seeds, with or without a water impermeable hull, are suitable for puffing. A process of puffing can for example be done, by pre-cooking and drying the seeds, followed by a heating step (e.g. frying in oil). Alternatively, the seeds can for example be puffed by explosion/gun puffing, where the raw or pre-cooked seeds are placed in a sealed drum that is rotated and heated from the outside until a certain pressure is obtained, the lid is released and all seeds puff at the same time, and escape the drum via the lid, and are collected in a bag where water vapour can escape.

Seeds, like maize, that comprise a water impermeable hull, which keeps the water inside the seed during heating, are suitable for popping. Popping is an (almost) explosive form of puffing, in which heating of the seeds causes starch gelatinization and pressure build-up due to steam formation until the hull bursts and the seed explosively expands to form a foamy structure.

The expanded gelatinized starch particles of the present invention can also be prepared by extrusion, e.g. by using an extrusion process as described in EP-A 0 087 847. In such an extrusion process, a starch material, e.g. seed endosperm, flour or starch, is fed into an extruder where the starch material is heated in the presence of water and optionally a gas forming expanding agent to gelatinize the starch and to build up pressure. When the heat processed starch material leaves the extruder, the pressure drop results in the formation of an expanded starch structure. The extruded material can be milled or otherwise comminuted to produce the extrusion expanded starch particles.

Preferably, the expanded gelatinized starch particles are comminuted after the puffing, popping or extrusion process. The comminuting can be carried using size reduction techniques known in the art. Preferably, comminution is carried out by milling, cutting, grinding or a combination thereof.

Comminution can carried out on dry expanded gelatinized starch material. Alternatively, comminution process can be carried out whilst the starch material is dispersed in a suitable liquid. Such wet comminution may for instance be carried out in liquid oil, preferably the oil phase of the savoury concentrate.

According to the invention, at least 80 wt. % of the expanded gelatinized starch particles passes a sieve with a mesh size of 2000 μm Preferably at least 80 wt. % of the expanded gelatinized starch particles passes a sieve with a mesh size of 1000 μm. More preferably at least 80 wt. % of the expanded gelatinized starch particles passes a sieve with a mesh size of 500 μm. If too many of the expanded gelatinized starch particles in the savoury concentrate are too large, they are likely to lead to a grainy/gritty mouthfeel upon consumption of the diluted savoury concentrate.

Preferably, not more than 15 wt. % of the expanded gelatinized starch particles passes a sieve with a mesh size of 100 μm or less, more preferably not more than 35 wt. % of the expanded gelatinized starch particles passes a sieve with a mesh size of 200 μm or less.

The expanded gelatinized starch particles can be suitably visualized in the final savoury concentrate by means of XRT (X-ray micro computed tomography, also known as micro-CT) or SEM (scanning electron microscopy). The expanded structure of the expanded gelatinized starch particles can suitably be recognised amongst the other ingredients in the savoury concentrate.

### Particles of Puffed Seed Endosperm

In a preferred embodiment of the invention the expanded gelatinized starch particles are particles of puffed seed endosperm.

Preferably, the particles of puffed seed endosperm are dispersed in the oil phase in a concentration of 1 to 30 wt. %, more preferably 2-25 wt. %, most preferably 4-20 wt. %, by weight of the combined weight of the liquid oil and the particles of puffed seed endosperm.

The particles of puffed seed endosperm preferably have a bulk density that falls within the range of 5-200 g/I. More preferably, the particles of puffed seed endosperm have a bulk density that falls within the range of 15-150 g/I, most preferably a bulk density that falls within the range of 30-100 g/I.

Puffable seeds are seeds with endosperm that can be puffed or popped to form an expanded starch structure as described herein before. Puffable seeds are well-known to the skilled person. The puffed seed endosperm according to the invention preferably originates from amaranth, barley, maize, millet, oat, rice, sorghum, spelt, wheat, buckwheat, makhana, quinoa, soybeans and mixtures thereof. More preferably, the puffed seed endosperm originates from maize, buckwheat, amaranth, rice, quinoa and mixtures thereof.

In some applications, maize and buckwheat are preferred as the puffable seeds, because of their relatively high weight efficiency and also because of their pleasant sensorial properties: puffed maize or puffed buckwheat gives a pleasant soft mouthfeel upon consumption of the diluted savoury concentrate. In other applications, rice may be preferred, because of its neutral taste profile.

Consequently, the puffed seed endosperm preferably originates from maize, buckwheat, rice and combinations thereof. Most preferably, the puffed seed endosperm preferably originates from maize, buckwheat and combinations thereof.

In a preferred embodiment the puffed seed endosperm originates from maize. Maize (Zea mays) is a well-known crop species in the Poaceae family. Maize is cultivated around the world. The fruits or maize cobs contain the seeds of the maize, known as maize kernels. Maize kernels have a typical shape and structure, which typically includes a germ, endosperm and pericarp. The endosperm tissue of maize is particularly rich in starches, typically amylase and amylopectin. In addition, it has a relatively high fibre content. The pericarp (hull) of maize kernels is relatively strong and water-impermeable.

The general process of puffing maize endosperm and the typical structure resulting therefrom are well-known in the art. One of the most well-known ways of puffing maize endosperm is by popping popcorn. It is generally known that it is the combination of endosperm and hull properties of maize and the right humidity that make maize kernels poppable.

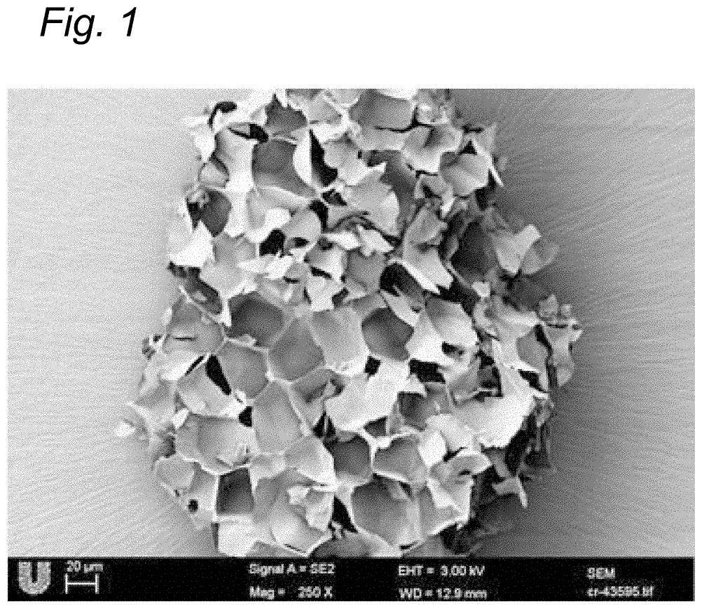

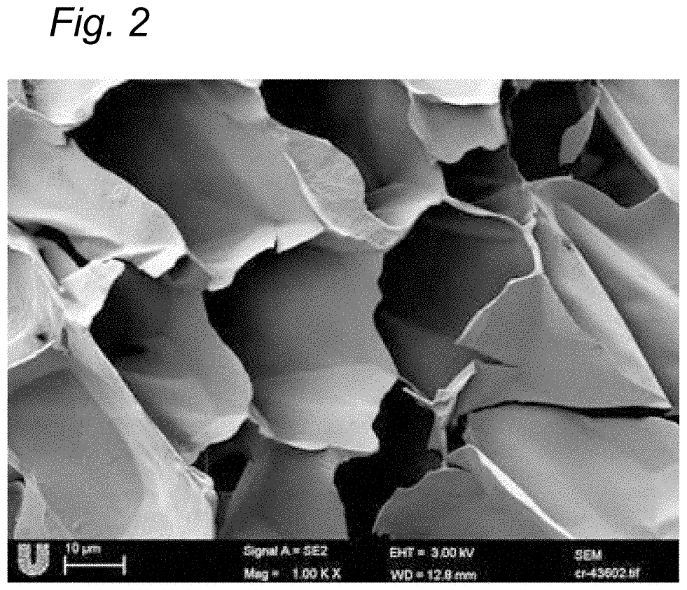

The expanded starch structure that is obtained by popping popcorn is especially preferable for the particles used in the present invention. FIGS. 1 and 2 show the expanded starch structure that was obtained upon popping of popcorn. This expanded starch structure includes bubble-shaped pores, some of which may be open and some of which may be closed and/or intact (after comminution). It is hypothesized that each bubble of the expanded starch structure is formed from an individual starch granule.

Therefore the particles of puffed seed endosperm are preferably obtained from puffed popcorn, more preferably from popped popcorn. Certain maize cultivars have been specifically bred for their suitability to be popped, including for instance Zea mays var. everta. Therefore, the particles of puffed seed endosperm are most preferably sourced from Zea mays var. everta.

### Extrusion Expanded Starch Particles

In another preferred embodiment of the invention, the expanded gelatinized starch particles are extrusion expanded starch particles.

Preferably, the extrusion expanded starch particles are dispersed in the oil phase in a concentration of 1 to 35 wt. %, more preferably 2-33 wt. %, most preferably 4-30 wt. %, by weight of the combined weight of the liquid oil and the extrusion expanded starch particles.

The extrusion expanded starch particles preferably have a bulk density that falls within the range of 5-220 g/I. More preferably, the extrusion expanded starch particles have a bulk density that falls within the range of 15-190 g/I, most preferably a bulk density that falls within the range of 30-170 g/I.

The starch in the extrusion expanded starch particles preferably originates from amaranth, barley, maize, millet, oat, rice, sorghum, spelt, wheat, buckwheat, makhana, quinoa, soybeans, potato, tapioca and combinations thereof. More preferably, the starch in the extrusion expanded starch particles originates from maize, potato, tapioca and combinations thereof.

### Method

A second aspect of the invention relates to a method for the preparation of a savoury concentrate, said method comprises the combining of the following components:
a. 100 parts by weight of an oil phase comprising liquid oil;
b. 0.5-35 parts by weight of expanded gelatinized starch particles, said particles comprising, by weight of the particles, at least 50 wt. % of starch, and wherein at least 80 wt. % of said particles passes a sieve with a mesh size of 2000 μm;
c. 4-100 parts by weight of an edible salt selected from sodium chloride, potassium chloride and combinations thereof;
d. 1-170 parts by weight of savoury taste giving ingredients selected from glutamate, 5′-ribonucleotides, sucrose, glucose, fructose, lactic acid, citric acid and combinations thereof;
wherein the prepared savoury concentrate comprises not more than 10 wt. % water.

The embodiments that have been described herein before in the context of the savoury concentrate of the invention equally apply to this method, according to the invention, for the preparation of a savoury concentrate.

Preferably, 1-33 parts by weight of expanded gelatinized starch particles are combined with 100 parts by weight of oil phase. More preferably, 2-30 parts by weight of expanded gelatinized starch particles are combined with 100 parts by weight of oil phase. Most preferably, 4-27 parts by weight of expanded gelatinized starch particles are combined with 100 parts by weight of oil phase.

Preferably, 100 parts by weight of the oil phase are combined with 6-85 parts by weight of the edible salt. More preferably, 100 parts by weight of the oil phase are combined with 10-65 parts by weight of the edible salt.

Preferably, 100 parts by weight of the oil phase are combined with 6-130 parts by weight of the savoury taste giving ingredients. More preferably, 100 parts by weight of the oil phase are combined with 12-100 parts by weight of the savoury taste giving ingredients.

The prepared savoury concentrate preferably comprises 33-75 wt. %, by weight of the concentrate, of the oil phase. More preferably, the prepared savoury concentrate comprises 36-70 wt. %, by weight of the concentrate, of the oil phase. Most preferably, the prepared savoury concentrate comprises 40-65 wt. %, by weight of the concentrate, of the oil phase.

Preferably, the oil phase has a solid fat content at 20° C. (N₂₀) of 0-15% and a liquid oil content at 20° C. that equals 100%-N₂₀.

In a preferred embodiment, the oil phase is prepared by blending two or more different oils or oil fractions to obtain the oil phase. For example, a melted high melting fat component can be mixed with a liquid oil to obtain an oil phase.

The prepared savoury concentrate preferably comprises up to 9 wt. %, by weight of the concentrate, of water. More preferably, the prepared savoury concentrate comprises up to 8 wt. %, by weight of the concentrate, of water.

In a preferred embodiment 100 parts by weight of the oil phase are combined with 0.1-165 parts by weight of particulate plant material selected from herbs, spices, vegetables and combinations thereof. More preferably, 100 parts by weight of the oil phase are combined with 1-135 parts by weight of said particulate plant material. Most preferably, 100 parts by weight of the oil phase are combined with 6-115 parts by weight of said particulate plant material.

In a preferred embodiment, the method comprises the steps of:
dispersing the expanded gelatinized starch particles into the oil phase to obtain a dispersion; and
combining said dispersion with the remaining components of the savoury concentrate.

In another preferred embodiment, the method comprises the steps of:
combining the expanded gelatinized starch particles with the other components of the savoury concentrate, except for the oil phase, to obtain a mixture; and
combining the mixture with the oil phase.

Preferably, the method of the invention produces the savoury concentrate according to the invention as described herein before.

The savoury concentrate that is produced by the present method is preferably filled into a container (e.g. a jar), a pouch or a sachet.

### Process of Preparing a Ready-to-Eat Savoury Product

A third aspect of the invention relates to a process of preparing a ready-to-eat savoury product, said process comprising the steps of mixing 1 part by weight of the savoury concentrate according to the present invention with 1-50 parts by weight of other edible components.

Preferably, 1 part by weight of the savoury concentrate is mixed with 1-40 parts by weight of aqueous liquid. More preferably, the present process comprises mixing 1 part by weight of the savoury concentrate with 4-20 parts by weight of aqueous liquid.

Examples of ready-to-eat savoury products that can be prepared in this manner include bouillons, soups, sauces, gravies, pan dishes or oven dishes.

According to one embodiment, the savoury concentrate is mixed with hot aqueous liquid having a temperature of at least 50° C., preferably of at least 70° C.

In accordance with another embodiment, the savoury concentrate is mixed with cold water having a temperature of less than 30° C. and the resulting mixture is subsequently heated to a temperature in excess of 70° C.

The aqueous liquid that is mixed with the savoury concentrate typically contains at least 70 wt. %, more preferably at least 80 wt. % of water.

The invention is further illustrated by means of the following non-limiting examples.

### EXAMPLES

### Characterization Methods

### Bulk Density Determination:

The bulk density of the particles was measured by placing a metered glass cylinder (Hirshmann, techcolor, Germany 250 ml) on a balance with a funnel on top. The cylinder was filled (close to the funnel), the particle weight and volume were recorded, and the bulk density was calculated in g/L.

### Evaluation Methods

### Oil Exudation Assessment

The savoury concentrates were assessed for exudation of oil after 7 days of storage at ambient temperature. The lid of the savoury concentrate was removed and the savoury concentrate was subsequently turned at an angle between 135 and 180 degrees, where 180 degrees means completely upside down, for a time period of 1 minute. The oil that ran freely from the savoury concentrate was filtered using a tea sieve, and collected on a weighing plate. The amount of free oil was determined as weight percentage of the weight of the total savoury concentrate, i.e. the weight of the savoury concentrate before the weight of the free oil had been determined.

### Transit Temperature Simulation

To simulate tropical transit temperature conditions, the samples were placed overnight in an oven at 60° C. The next day, after letting the samples cool down to ambient temperature, the samples were inspected visually for undesired layer formation. In case a layer of free oil was formed, the weight percentage of this layer was determined according to the method described above.

### Example 1

Two types of expanded gelatinized starch particles were applied in the examples.

### Preparation of Particles of Puffed Maize Endosperm

Microwaveable popcorn (Popcorn microwave zout′, Albert Heijn, Zaandam, The Netherlands) was puffed in a microwave oven for 2 minutes at 1100 Watt. The puffed kernels were spread out to cool down. Seeds that did not puff were removed. This was followed by grinding the puffed kernels in a Thermomix (Vorwerk, Germany) for 3 minutes at speed 10, using the stainless steel cutting blades. The resulting powder was then passed in 30 gram aliquots through a stack of stainless steel sieves (apertures 2.0 mm and 1.0 mm respectively), using a vibratory sieve shaker (type AS200 digit, Retsch Gmbh & Co., Haan, Germany) pre-set at 60 Hz for 5 minutes. The powder fraction passing the last sieve was collected and stored in an airtight container until further use.

A part of the powder fraction was sieved further to determine the particle size distribution. About 20 wt. % passed a sieve with a mesh size of 200 μm and 7 wt. % passed a sieve with a mesh size 100 μm.

The bulk density of the particles of puffed maize endosperm was about 58 g/L.

### Extrusion Expanded Starch Particles

Aero-Myl 33 (Sudstärke, Germany) was applied as extrusion expanded potato starch particles. The bulk density of Aero-Myl 33 was about 140 g/L. Sieve analysis shows that at least 95 wt. % of the particles had a particle size below 1.0 mm. Aero-Myl 33 has a moisture content of about 6 wt. %.

### Example 2

The savoury concentrates were prepared using the following procedure:

### Oil Phase Preparation

In case the oil phase comprises palm oil stearin, the oil phase was prepared as follows:
A container was filled with oil at a temperature of 5° C.
A Silverson mixing head (type L4RT; fitted with 1 mm hole emulsion screen mixing head) was placed in the oil. The Silverson mixer was started operating at 3000 rpm.
Palm oil stearin was heated to over 80° C. When the heated palm oil stearin was cooled down to 65° C., it was slowly poured into the oil, close to the mixing head to optimize the mixing of the palm oil stearin with the oil. Subsequently, the mixer speed was gradually increased to 7000 rpm.
After complete addition of the molten palm oil stearine, the mixture was sheared for an additional 2 minutes at a speed of 7000 rpm.
The resulting oil phase was stored overnight a 5° C. and used the next day.

### Savoury Concentrate Preparation

The savoury concentrates were prepared as follows:
If applicable, the right amount of expanded gelatinized starch particles were mixed with the oil phase manually, using a spoon.
All the dry ingredients were weighed and then mixed together for about 1 minute at speed 1, until homogeneous, in a Kenwood (type Chef classic or Chef premiere) kitchen machine, using the K-beater mixing tool.
The oil phase, including the expanded gelatinized starch particles if applicable, was added to the dry ingredients mixture and mixed for 2 minutes applying the K-beater mixing tool at speed 2 until homogeneous.
About 80 grams of the final savoury concentrate was filled and capped in plastic (PP) jars with the following dimensions:
   bottom diameter: 4.9 cm
   top diameter: 5.2 cm
   height of the container: 6.3 cm
   The savoury concentrates were stored at ambient temperature.

### Example 3

Savoury concentrates were prepared on the basis of the recipes shown in Table 1, using the procedure as described in Example 2. The prepared savoury concentrates were evaluated using the evaluation methods as described herein before. The results are shown in Table 1.

TABLE 1

| | A | 1 | 2 | 3 |
|---|---|---|---|---|
| Ingredients | (wt. %) | (wt. %) | (wt. %) | (wt. %) |
| Sunflower oil | 45.7 | 41.6 | 0.0 | 34.2 |
| Rapeseed oil | 0.0 | 0.0 | 52.0 | 0.0 |
| Palm oil stearin (Iodine value = | 0.5 | 0.5 | 0.0 | 0.0 |
| 14) | | | | |
| Puffed maize endosperm (as | 0.0 | 4.1 | 11.0 | 12.0 |
| described in example 1) | | | | |
| Sodium chloride | 4.3 | 4.3 | 1.5 | 4.3 |
| Potassium chloride | 5.7 | 5.7 | 2.5 | 5.7 |
| Sugar | 15.7 | 15.7 | 15.7 | 15.7 |
| Powdered taste giving | 24.8 | 24.8 | 14.1 | 24.8 |
| ingredients | | | | |
| Dried red bell pepper pieces | 2.8 | 2.8 | 2.8 | 2.8 |
| Dried basil | 0.2 | 0.2 | 0.2 | 0.2 |
| Dried parsley | 0.2 | 0.2 | 0.2 | 0.2 |
| Total (wt. %) | 100 | 100 | 100 | 100 |
| wt. % expanded gelatinized | 0.0 | 9.0 | 17.5 | 26.0 |
| starch particles based on | | | | |
| (liquid oil + particles) | | | | |
| Ratio dry matter (wt.) to liquid | 1.2 | 1.4 | 0.9 | 1.9 |
| oil (wt.) | | | | |

Results

| | | | | |
|---|---|---|---|---|
| wt. % oil exudation at ambient | 19 | 0 | 0 | 0 |
| temperature | | | | |
| Layer formation after storage | n.d. ¹ | No | No | No |
| at 60° C. | | | | |
| wt. % oil exudation after | n.d. | 0 | 0 | 0 |
| storage at 60° C. | | | | |

¹ n.d. = not determined

### Example 4

Savoury concentrates were prepared on the basis of the recipes shown in Table 2, using the procedure as described in Example 2. The prepared savoury concentrates were evaluated using the evaluation methods as described herein before. The results are shown in Table 2.

TABLE 2

| | B | C | D | E | 4 |
|---|---|---|---|---|---|
| Ingredients | (wt. %) | (wt. %) | (wt. %) | (wt. %) | (wt. %) |
| Sunflower oil | 40.2 | 40.2 | 40.2 | 40.2 | 40.2 |
| Puffed maize endosperm | 0.0 | 0.0 | 0.0 | 0.0 | 6.0 |
| (as described in example | | | | | |
| 1) | | | | | |
| Sodium chloride | 4.3 | 4.3 | 4.3 | 4.3 | 4.3 |
| Potassium chloride | 5.7 | 5.7 | 5.7 | 5.7 | 5.7 |
| Sugar | 15.7 | 15.7 | 15.7 | 15.7 | 15.7 |
| Powdered taste giving | 24.8 | 24.8 | 30.9 | 24.8 | 24.8 |
| ingredients | | | | | |
| Potato starch | 6.0 | 0.0 | 0.0 | 0.0 | 0.0 |
| Dried red bell pepper | 2.8 | 8.9 | 2.8 | 2.8 | 2.8 |
| pieces | | | | | |
| Dried basil | 0.2 | 0.2 | 0.2 | 6.2 | 0.2 |
| Dried parsley | 0.2 | 0.2 | 0.2 | 0.2 | 0.2 |
| Total (wt. %) | 100 | 100 | 100 | 100 | 100 |
| wt. % expanded | 0.0 | 0.0 | 0.0 | 0.0 | 13.0 |
| gelatinized starch | | | | | |
| particles based on | | | | | |
| (liquid oil + particles) | | | | | |
| Ratio dry matter (wt.) to | 1.5 | 1.5 | 1.5 | 1.5 | 1.5 |
| liquid oil (wt.) | | | | | |

Results

| | | | | | |
|---|---|---|---|---|---|
| wt. % oil exudation at | 16 | 13 | 12 | 16 | 0 |
| ambient temperature | | | | | |
| Layer formation after | n.d. ¹ | n.d. | n.d. | n.d. | No |
| storage at 60° C. | | | | | |
| wt. % oil exudation | n.d. | n.d. | n.d. | n.d. | 0 |
| after storage at 60° C. | | | | | |

¹ n.d. = not determined

### Example 5

Savoury concentrates were prepared on the basis of the recipes shown in Table 3, using the procedure as described in Example 2. The prepared savoury concentrates were evaluated using the evaluation methods as described herein before. The results are shown in Table 3.

TABLE 3

| | F | G | 5 | 6 | 7 | 8 |
|---|---|---|---|---|---|---|
| Ingredients | (wt. %) | (wt. %) | (wt. %) | (wt. %) | (wt. %) | (wt. %) |
| Sunflower oil | 44.0 | 34.7 | 40.2 | 38.4 | 36.6 | 39.40 |
| Palm oil stearin | 2.2 | 11.6 | 2.0 | 4.0 | 6.0 | 6.45 |
| (Iodine value = 14) | | | | | | |
| Puffed maize | 0.0 | 0.0 | 4.0 | 3.8 | 3.6 | 0.4 |
| endosperm | | | | | | |
| (as described in | | | | | | |
| example 1) | | | | | | |
| Sodium chloride | 4.3 | 4.3 | 4.3 | 4.3 | 4.3 | 4.3 |
| Potassium | 5.7 | 5.7 | 5.7 | 5.7 | 5.7 | 5.7 |
| chloride | | | | | | |
| Sugar | 15.7 | 15.7 | 15.7 | 15.7 | 15.7 | 15.7 |
| Powdered taste | 24.8 | 24.8 | 24.8 | 24.8 | 24.8 | 24.8 |
| giving ingredients | | | | | | |
| Dried red bell | 2.8 | 2.8 | 2.8 | 2.8 | 2.8 | 2.8 |
| pepper pieces | | | | | | |
| Dried basil | 0.2 | 0.2 | 0.2 | 0.2 | 0.2 | 0.2 |
| Dried parsley | 0.2 | 0.2 | 0.2 | 0.2 | 0.2 | 0.2 |
| Total (wt. %) | 100 | 100 | 100 | 100 | 100 | 100 |
| wt. % expanded | 0.0 | 0.0 | 9.0 | 9.0 | 9.0 | 1.0 |
| gelatinized starch | | | | | | |
| particles based | | | | | | |
| on (liquid oil + | | | | | | |
| particles) | | | | | | |
| Ratio dry matter | 1.2 | 1.2 | 1.4 | 1.4 | 1.3 | 1.2 |
| (wt.) to liquid oil | | | | | | |
| (wt.) | | | | | | |

Results

| | | | | | | |
|---|---|---|---|---|---|---|
| wt. % oil | 0 | 0 | 0 | 0 | 0 | 0 |
| exudation at | | | | | | |
| ambient | | | | | | |
| temperature | | | | | | |
| Layer formation | Yes | Yes | No | No | No | No |
| after storage | | | | | | |
| at 60° C. | | | | | | |
| wt. % oil | 3.0 | n.a. ¹ | 0 | 0 | 0 | 0 |
| exudation after | | | | | | |
| storage at | | | | | | |
| 60° C. | | | | | | |

¹ n.a. = not applicable

### Example 6

Savoury concentrates were prepared on the basis of the recipes shown in Table 4, using the procedure as described in Example 2. The prepared savoury concentrates were evaluated using the evaluation methods as described herein before. The results are shown in Table 4.

TABLE 4

| | 9 | 10 |
|---|---|---|
| Ingredients | (wt. %) | (wt. %) |
| Soybean oil | 50.0 | 35.0 |
| Aero-myl 33 (as described in example 1) | 11.0 | 8.8 |
| Sodium chloride | 15.0 | 5.0 |
| Potassium chloride | 10.0 | 6.0 |
| Sugar | 2.0 | 16.0 |
| Powdered taste giving ingredients | 8.8 | 25.0 |
| Dried red bell pepper pieces | 2.8 | 3.0 |
| Dried basil | 0.2 | 0.6 |
| Dried parsley | 0.2 | 0.6 |
| Total (wt. %) | 100 | 100 |
| wt. % expanded gelatinized starch particles | 18.0 | 20.0 |
| based on (liquid oil + particles) | | |
| Ratio dry matter (wt.) to liquid oil (wt.) | 1.0 | 1.9 |

Results

| | | |
|---|---|---|
| wt. % oil exudation at ambient temperature | 0 | 0 |
| Layer formation after storage at 60° C. | No | No |
| wt. % oil exudation after storage at 60° C. | 0 | 0 |

### Example 7

### Scanning Electron Microscopy Characterization of Particles of Puffed Maize Endosperm.

An amount of the particles of puffed maize endosperm was put on a Gatan sample holder with conductive double sided sticky tape. The excess of particles were removed by gently holding the holder upside-down. Subsequently, the holder containing particles was transferred into a Gatan 2500 transfer system which was kept at −45° C. The particles were coated with platinum for 2 times at 180 seconds to prevent charging during observation in the microscope. Finally, the particles were transferred into a Zeiss Auriga field emission SEM (−45° C.) and imaged at 3 kV.

An example of a particle of ground puffed maize endosperm is shown in the micrograph of FIG. 1. The scale bar corresponds to 20 μm. A close-up of the same particle is shown in the micrograph of FIG. 2, in which the scale bar corresponds to 10 μm. Both micrographs show the structure that is typical of puffed popcorn. FIGS. 1 and 2 show the polygonal structure of the inflated starch granules constituting the foam-like structure of the popped maize. The open foam bubbles at the outside of the particle are believed to have been caused by the grinding process.

1.-15. (canceled)

16. A savoury concentrate comprising:
a) at least 30 wt. %, by weight of the concentrate, of an oil phase comprising liquid oil;
b) 3-30 wt. %, by weight of the concentrate, of an edible salt selected from sodium chloride, potassium chloride and combinations thereof;
c) 1-50 wt. %, by weight of the concentrate, of savoury taste giving ingredients selected from glutamate, 5′-ribonucleotides, sucrose, glucose, fructose, lactic acid, citric acid and combinations thereof;
d) up to 10 wt. %, by weight of the concentrate, of water; and
e) expanded gelatinized starch particles, said particles comprising, by weight of the particles, at least 50 wt. % of starch, and wherein at least 80 wt. % of said particles passes a sieve with a mesh size of 2000 μm;
wherein the ratio of dry matter by weight to the oil phase by weight is lies in the range 2:1 to 0.2:1,
wherein the expanded gelatinized starch particles are dispersed in the oil phase in a concentration of 0.5 to 35 wt. %, by weight of the combined weight of the liquid oil and the gelatinized starch particles, whereby
said water content of the savoury concentrate refers to the total water content, thus including the water that is present within the ingredients of the savoury concentrate.

17. The savoury concentrate according to claim 16, wherein the oil phase has a solid fat content at 20° C. (N₂₀) of 0-15% and a liquid oil content at 20° C. that equals 100%-N₂₀.

18. The savoury concentrate according to claim 16, wherein the sum of (i) the wt. % of expanded gelatinized starch particles, by weight of the combined weight of the liquid oil and the gelatinized starch particles, and (ii) the percentage of solid fat content in the oil phase at 20° C. (N₂₀), lies within the range of 5-35.

19. The savoury concentrate according to claim 16, wherein the expanded gelatinized starch particles are selected from:
I. particles of puffed seed endosperm;
II. extrusion expanded starch particles; and
combinations thereof.

20. The savoury concentrate according to claim 16, wherein the expanded gelatinized starch particles are dispersed in the oil phase in a concentration of 1 to 33 wt. %, by weight of the combined weight of the liquid oil and the expanded gelatinized starch particles.

21. The savoury concentrate according to claim 16, wherein the concentrate comprises, by weight of the concentrate, 35-75 wt. % of the oil phase.

22. The savoury concentrate according to claim 16, wherein the components a) to e) together constitute at least 60 wt. % of the savoury concentrate.

23. The savoury concentrate according to claim 16, wherein the savoury concentrate comprises:
a) 40-65 wt. %, by weight of the concentrate, of the oil phase having a solid fat content at 20° C. (N₂₀) of 0-5% and a liquid oil content at 20° C. that equals 100%-N₂₀;
b) 8-20 wt. %, by weight of the concentrate, of an edible salt selected from sodium chloride, potassium chloride and combinations thereof;
c) 10-30 wt. %, by weight of the concentrate, of savoury taste giving ingredients selected from glutamate, 5′-ribonucleotides, sucrose, glucose, fructose, lactic acid, citric acid and combinations thereof;
d) up to 8 wt. %, by weight of the concentrate, of water;
e) expanded gelatinized starch particles, said particles comprising, by weight of the particles, at least 50 wt. % of starch, and wherein at least 80 wt. % of said particles passes a sieve with a mesh size of 2000 μm;
f) 5-35 wt. % of particulate plant material selected from herbs, spices, vegetables and combinations thereof; and
wherein the expanded gelatinized starch particles are dispersed in the oil phase in a concentration of 4 to 27 wt. %, by weight of the combined weight of the liquid oil and the gelatinized starch particles; and
wherein the sum of (i) the wt. % of expanded gelatinized starch particles, by weight of the combined weight of the liquid oil and the gelatinized starch particles, and (ii) the percentage of solid fat content in the oil phase at 20° C. (N₂₀), lies within the range of 10-25.

24. A method for the preparation of a savoury concentrate, said method comprises the combining of the following components:
a. 100 parts by weight of an oil phase comprising liquid oil;
b. 0.5-35 parts by weight of expanded gelatinized starch particles, said particles comprising, by weight of the particles, at least 50 wt. % of starch, and wherein at least 80 wt. % of said particles passes a sieve with a mesh size of 2000 μm;
c. 4-100 parts by weight of an edible salt selected from sodium chloride, potassium chloride and combinations thereof;
d. 1-170 parts by weight of savoury taste giving ingredients selected from glutamate, 5′-ribonucleotides, sucrose, glucose, fructose, lactic acid, citric acid and combinations thereof; wherein the prepared savoury concentrate comprises not more than 10 wt. % water, whereby said water content of the savoury concentrate refers to the total water content, thus including the water that is present within the ingredients of the savoury concentrate.

25. The method according to claim 24, wherein the oil phase has a solid fat content at 20° C. (N₂₀) of 0-15% and a liquid oil content at 20° C. that equals 100%-N₂₀.

26. The method according to claim 24, wherein the expanded gelatinized starch particles have a bulk density within the range of 5-220 g/l.

27. The method according to claim 24, wherein not more than 15 wt. % of the expanded gelatinized starch particles passes a sieve with a mesh size of 100 μm or less.

28. The method according to claim 24, wherein the method produces a savoury concentrate comprising:
a) at least 30 wt. %, by weight of the concentrate, of an oil phase comprising liquid oil;
b) 3-30 wt. %, by weight of the concentrate, of an edible salt selected from sodium chloride, potassium chloride and combinations thereof;
c) 1-50 wt. %, by weight of the concentrate, of savoury taste giving ingredients selected from glutamate, 5′-ribonucleotides, sucrose, glucose, fructose, lactic acid, citric acid and combinations thereof;
d) up to 10 wt. %, by weight of the concentrate, of water; and
e) expanded gelatinized starch particles, said particles comprising, by weight of the particles, at least 50 wt. % of starch, and wherein at least 80 wt. % of said particles passes a sieve with a mesh size of 2000 μm;
wherein the ratio of dry matter by weight to the oil phase by weight is lies in the range 2:1 to 0.2:1,
wherein the expanded gelatinized starch particles are dispersed in the oil phase in a concentration of 0.5 to 35 wt. %, by weight of the combined weight of the liquid oil and the gelatinized starch particles, whereby
said water content of the savoury concentrate refers to the total water content, thus including the water that is present within the ingredients of the savoury concentrate.

29. A process for preparing a ready-to-eat savoury product, said process comprising the steps of mixing 1 part by weight of the savoury concentrate, according to claim 16, with 1-50 parts by weight of other edible components.
